(19) United States
(12) Patent Application Publication
(10) Pub. No.: US 2023/0239144 A1
(43) Pub. Date: Jul. 27, 2023

(54) DETERMINISTIC CHAOS-BASED QUANTUM COMPUTER RESISTANT DATA ENCRYPTION FOR LARGE SCALE WIDE AREA NETWORK SOLUTIONS

(71) Applicant: William David Schwaderer, Sparks, NV (US)

(72) Inventor: William David Schwaderer, Sparks, NV (US)

(21) Appl. No.: 18/156,998

(22) Filed: Jan. 19, 2023

Related U.S. Application Data
(60) Provisional application No. 63/266,994, filed on Jan. 21, 2022.

(51) Int. Cl. H04L 9/08; H04L 9/30

(52) U.S. Cl. CPC H04L 9/0869; H04L 9/0852; H04L 9/3093

(57) ABSTRACT

A computer-implemented method can include: constructing and initializing Pseudo Random Generator Resources using a multiplicity of secret seed values or secret data values known to a first and second communication device; deriving a session key based, at least in part, on the secret seed, secret data values, Multi-Factor Authentication methods, or Pseudo Random Number Generator Resource generated output; receiving from the first communications device, at the second communications device, data encrypted with the session key or Deterministic Chaos obfuscation methods; and decrypting the data at the second communications device using the session key or Deterministic Chaos de-obfuscation methods.

### CROSS REFERENCE TO RELATED APPLICATIONS

The present application claims priority to U.S. Provisional Application No. 63/266,994, entitled “DETERMINISTIC CHAOS-BASED QUANTUM COMPUTER RESISTANT DATA ENCRYPTION FOR LARGE SCALE WIDE AREA NETWORK SOLUTIONS”, and filed on Jan. 21, 2022. The entire contents of the above-listed application are hereby incorporated by reference for all purposes.

### BACKGROUND AND SUMMARY

Those skilled in the art will appreciate that ShapeShift™ is a plaintext data obfuscation (encryption) approach that has a novel Deterministic Chaos foundation. ShapeShift uses heterogeneous Pseudo Random Number Generator methods that produce high entropy pseudo random values. The values identify encryption, shuffling, and scrambling operations and operational values. This approach allows ShapeShift ciphertext output to exhibit a mathematical “Barren Plateau” characteristic that significantly impedes Quantum Computer periodicity analysis and Machine Learning decryption attacks.

### DETAILED DESCRIPTION

Certain embodiments of the disclosed technology include methodologies for establishing secure data communication transmissions in a post-Quantum Computer context. The methodologies can include the following:

receiving, from a first communications device, at a second communications device, a multiplicity of secret seed or secret data values, or otherwise obtaining the secret seed or secret data values by other means;

using the multiplicity of secret seed or secret data values, at least in part, to construct identical Pseudo Random Number Generator Resources at a first communications device and at a second communications device;

identically initializing the identical Pseudo Random Number Generator Resources at a first communications device and at a second communications device using, at least in part, the multiplicity of secret seed or secret data values;

the second communications device receiving from the first communications device, data encrypted, or obfuscated using, at least in part, the secret seed or secret data values or values the first communications device's Pseudo Random Number Generator Resource generated for use by Deterministic Chaos obfuscation methods; and

the second communications device decrypting, or de-obfuscating the received data using, at least in part, the secret seed or secret data values or identical values its Pseudo Random Number Generator Resource generated for use by Deterministic Chaos de-obfuscation methods.

In a first example, a computer-implemented method can include: constructing and initializing Pseudo Random Generator Resources using a multiplicity of secret seed values or secret data values known to a first and second communication device; deriving a session key based, at least in part, on the secret seed, secret data values, Multi-Factor Authentication methods, or Pseudo Random Number Generator Resource generated output; receiving from the first communications device, at the second communications device, data encrypted with the session key or Deterministic Chaos obfuscation methods; and decrypting the data at the second communications device using the session key or Deterministic Chaos de-obfuscation methods. The exchanged session traffic may include authentication information. Alternatively or in addition thereto, one or more processors may be configured to verify that the session traffic was received from an expected communications device based on the authentication information.

In certain embodiments, the computer-implemented method may further include receiving, from the first communications device, the multiplicity of secret seed values or secret data values as a plurality of encrypted secret seed values or secret data values that are encrypted with a Quantum Computer resistant key. In such embodiments, the Quantum Computer resistant key can be generated using a code-based Quantum Computer resistant encryption algorithm such as McEliece. Alternatively or in addition thereto, the Quantum Computer resistant key can be generated using a lattice-based Quantum Computer resistant encryption algorithm such as Kyber.

In certain embodiments, the computer-implemented method may further include obtaining the multiplicity of secret seed values or secret data values via a plurality of key exchanges between the first communications device and second communications devices.

In certain embodiments, the computer-implemented method may further include establishing a secure connection between the first communications device and the second communications device and receiving the multiplicity of secret seed or secret data values via plurality of secure connections.

In certain embodiments, the computer-implemented method may further include verifying that the first communications device's Pseudo Random Generator Resource output matches the second communications device's Pseudo Random Generator Resource output.

In certain embodiments, the computer-implemented method may further include encrypting other data using the session key to obtain encrypted other data, and one communications device transmitting the encrypted other data to the other communications device.

In another example, a device can include: an interface unit configured to enable network communications; a memory; and one or more processors coupled to the interface unit and the memory and configured to: construct and initialize a Pseudo Random Number Generator Resource using, at least in part, a multiplicity of secret seed values or secret data values; derive a session key based, at least in part, on the multiplicity of secret seed values, secret data values, Multi-Factor Authentication methods, or output from the Pseudo Random Number Generator Resource; receive data encrypted with the session key or Deterministic Chaos obfuscation methods; and decrypt the data using the session key or Deterministic Chaos de-obfuscation methods.

The one or more processors may be further configured to receive the multiplicity of secret seed values or secret data values encrypted with a Quantum Computer resistant key. In such embodiments, the Quantum Computer resistant key may be generated using a code-based encryption algorithm such as the McEliece algorithm. Alternatively or in addition thereto, the Quantum Computer resistant key may be generated using a lattice-based encryption algorithm such as the CRYSTALS-Dilithium (Lattice) encryption algorithm.

In certain embodiments, the one or more processors may be further configured to configured to obtain the multiplicity of secret seed or secret data values via a plurality of key exchanges.

In certain embodiments, the one or more processors may be further configured to establish a multiplicity of secure connections with a multiplicity of communications devices, and wherein the multiplicity of processors are configured to receive the multiplicity of secret seed or secret data values by receiving the multiplicity of secret seed or secret data values via a multiplicity of secure connections.

In certain embodiments, the exchanged session traffic may include authentication information. In such embodiments, the one or more processors may be further configured to verify that the session traffic was received from an expected communications device based on the authentication information.

In certain embodiments, the exchanged session traffic may verify that the first communications device's Pseudo Random Generator Resource output matches the second communications device's Pseudo Random Generator Resource output.

In certain embodiments, the exchanged session traffic may encrypt other data using the session key to obtain encrypted other data, and one communications device transmitting the encrypted other data to the other communications device.

In another example, a non-transitory computer-readable storage media may be encoded with instructions that, when executed by a processor, cause the processor to: receive a plurality of encrypted secret seed values or secret data values; decrypt the multiplicity of encrypted secret seed values or secret data values to obtain the multiplicity of secret seed values and secret data values; construct and initialize a Pseudo Random Number Generator Resource using, at least in part, the multiplicity of secret seed values or secret data values; derive a session key based, at least in part, on the multiplicity of secret seed values, Multi-Factor Authentication methods, or secret data values and Pseudo Random Number Generator Resource generated output; receive data encrypted with the session key or by using Pseudo Random Number Generator Resource generated output and Deterministic Chaos obfuscation methods; and decrypt the data using the session key or by using Pseudo Random Number Generator Resource generated output and Deterministic Chaos de-obfuscation methods.

In certain embodiments, the encrypted secret seed and secret data values may be encrypted with a code-based Quantum Computer resistant key, such as a key computed using the McEliece encryption algorithm. Alternatively or in addition thereto, the encrypted secret seed and secret data values may be encrypted with a lattice-based Quantum Computer resistant key, such as a key computed using the CRYSTALS-Dilithium (Lattice) encryption algorithm.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like.

Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that may be accessed by a computing device. By way of example, and not limitation, computer-readable media may comprise computer storage media and communication media.

It will be appreciated that variants of the above-disclosed and other features and functions, or alternatives thereof, may be combined into many other different systems or applications.

Various presently unforeseen or unanticipated alternatives, modifications, variations, or improvements therein may be subsequently made by those skilled in the art which are also intended to be encompassed by the following claims.

1. A computer-implemented method, comprising:
constructing and initializing Pseudo Random Generator Resources using a multiplicity of secret seed values or secret data values known to a first and second communication device;
deriving a session key based, at least in part, on the secret seed, secret data values, Multi-Factor Authentication methods, or Pseudo Random Number Generator Resource generated output;
receiving from the first communications device, at the second communications device, data encrypted with the session key or Deterministic Chaos obfuscation methods; and
decrypting the data at the second communications device using the session key or Deterministic Chaos de-obfuscation methods.

2. The computer-implemented method of claim 1, further comprising receiving, from the first communications device, the multiplicity of secret seed values or secret data values as a plurality of encrypted secret seed values or secret data values that are encrypted with a Quantum Computer resistant key.

3. The computer-implemented method of claim 2, wherein the Quantum Computer resistant key is generated using a code-based Quantum Computer resistant encryption algorithm such as McEliece.

4. The computer-implemented method of claim 2, wherein the Quantum Computer resistant key is generated using a lattice-based Quantum Computer resistant encryption algorithm such as Kyber.

5. The computer-implemented method of claim 1, further comprising obtaining the multiplicity of secret seed values or secret data values via a plurality of key exchanges between the first communications device and second communications devices.

6. The computer-implemented method of claim 1, further comprising establishing a secure connection between the first communications device and the second communications device and receiving the multiplicity of secret seed or secret data values via plurality of secure connections.

7. The computer-implemented method of claim 1, further comprising verifying that the first communications device's Pseudo Random Generator Resource output matches the second communications device's Pseudo Random Generator Resource output.

8. The computer-implemented method of claim 1, further comprising encrypting other data using the session key to obtain encrypted other data, and one communications device transmitting the encrypted other data to the other communications device.

9. The computer-implemented method of claim 1, wherein exchanged session traffic includes authentication information.

10. The computer-implemented method of claim 1, wherein one or more processors are configured to verify that the session traffic was received from an expected communications device based on the authentication information.

11. A device, comprising:
an interface unit configured to enable network communications;
a memory; and
one or more processors coupled to the interface unit and the memory and configured to:
construct and initialize a Pseudo Random Number Generator Resource using, at least in part, a multiplicity of secret seed values or secret data values;
derive a session key based, at least in part, on the multiplicity of secret seed values, secret data values, Multi-Factor Authentication methods, or output from the Pseudo Random Number Generator Resource;
receive data encrypted with the session key or Deterministic Chaos obfuscation methods; and
decrypt the data using the session key or Deterministic Chaos de-obfuscation methods.

12. The device of claim 11 wherein the one or more processors are further configured to receive the multiplicity of secret seed values or secret data values encrypted with a Quantum Computer resistant key.

13. The device of claim 12, wherein the Quantum Computer resistant key is generated using a code-based encryption algorithm such as the McEliece algorithm.

14. The device of claim 12, wherein the Quantum Computer resistant key is generated using a lattice-based encryption algorithm such as the CRYSTALS-Dilithium (Lattice) encryption algorithm.

15. The device of claim 11, wherein the one or more processors are further configured to obtain the multiplicity of secret seed or secret data values via a plurality of key exchanges.

16. The device of claim 11, wherein the one or more processors are further configured to establish a multiplicity of secure connections with a multiplicity of communications devices, and wherein the multiplicity of processors are configured to receive the multiplicity of secret seed or secret data values by receiving the multiplicity of secret seed or secret data values via a multiplicity of secure connections.

17. The device of claim 11, wherein exchanged session traffic includes authentication information.

18. The device of claim 17, wherein the one or more processors are further configured to verify that the session traffic was received from an expected communications device based on the authentication information.

19. The device of claim 11, wherein exchanged session traffic verifies that the first communications device's Pseudo Random Generator Resource output matches the second communications device's Pseudo Random Generator Resource output.

20. The device of claim 11, wherein exchanged session traffic encrypts other data using the session key to obtain encrypted other data, and one communications device transmitting the encrypted other data to the other communications device.
